(19) United States
(12) Patent Application Publication
(10) Pub. No.: US 2023/0025020 A1
(43) Pub. Date: Jan. 26, 2023

(54) SOFT MAGNETIC ALLOY POWDER, MAGNETIC CORE, MAGNETIC APPLICATION COMPONENT, AND NOISE SUPPRESSION SHEET

(71) Applicant: Murata Manufacturing Co., Ltd., Kyoto-fu (JP)

(72) Inventors: Luan JIAN, Nagaokakyo-shi (JP); Kazuhiro HENMI, Nagaokakyo-shi (JP)

(73) Assignee: Murata Manufacturing Co., Ltd., Kyoto-fu (JP)

(21) Appl. No.: 17/935,779

(22) Filed: Sep. 27, 2022

Related U.S. Application Data
(63) Continuation of application No. PCT/JP2021/012719, filed on Mar. 25, 2021.

(30) Foreign Application Priority Data
Mar. 31, 2020 (JP) 2020-064421

(51) Int. Cl. H01F 1/147; B22F 1/054; C22C 38/02; C22C 38/00; C22C 38/16; B22F 1/065

(52) U.S. Cl. CPC H01F 1/147; B22F 1/054; C22C 38/02; C22C 38/002; C22C 38/16; C22C 38/008; B22F 1/065; B82Y 30/00

(57) ABSTRACT

A soft magnetic alloy powder includes soft magnetic alloy particles having an amorphous phase. Each of the soft magnetic alloy particles has chemical composition represented by FeₐSi_{b}B_{c}C_{d}PₑCu_{f}Sn_{g}M1ₕM2ᵢ, where M1 is one or more elements of Co and Ni, M2 is one or more elements of Ti, Zr, Hf, Nb, Ta, Mo, W, Cr, Al, Mn, Ag, V, Zn, As, Sb, Bi, Y, and a rare earth element, and 79≤a+h+i≤86, 0≤b≤5, 7.2≤c≤12.2, 0.1≤d≤3, 7.3≤c+d≤13.2, 0.5≤e≤10, 0.4≤f≤2, 0.3≤g≤6, 0≤h≤30, 0≤i≤5, and a+b+c+d+e+f+g+h+i=100 (parts by mol) are satisfied.

### CROSS-REFERENCE TO RELATED APPLICATIONS

This application claims benefit of priority to International Patent Application No. PCT/JP2021/012719, filed Mar. 25, 2021, and to Japanese Patent Application No. 2020-064421, filed Mar. 31, 2020, the entire contents of each are incorporated herein by reference.

### BACKGROUND

### Technical Field

The present disclosure relates to a soft magnetic alloy powder, a magnetic core, a magnetic application component, and a noise suppression sheet.

### Background Art

Magnetic application components such as motors, reactors, inductors, and various coils are required to operate at a large current. Therefore, a soft magnetic material used for an iron core (magnetic core) of a magnetic application component is required to be less likely to be saturated when a high magnetic field is applied. Therefore, a soft magnetic alloy powder having a high saturation flux density, such as a Fe-3.5Si powder, is preferred.

When an average minor-axis length/major-axis length ratio of soft magnetic alloy particles constituting a soft magnetic alloy powder is less than 1, the magnetic flux tends to concentrate at both ends of the major axis with respect to the external magnetic field and tends to be magnetically saturated. Therefore, the shape of the particles constituting the soft magnetic alloy powder is required to be close to a spherical shape.

In order to reduce an iron loss which is one of energy loss components of a magnetic application component, an iron core having a small coercive force is required. The coercive force of the iron core is determined by the coercive force of the soft magnetic alloy powder. However, the above-described Fe-3.5Si has a problem of a large coercive force. Examples of a soft magnetic alloy having a small coercive force include amorphous soft magnetic alloys. Examples of a soft magnetic alloy having a small coercive force and a high saturation flux density include Fe-based nanocrystalline alloys.

The larger the minor-axis length/major-axis length ratio of the soft magnetic alloy particles, the smaller the influence of the diamagnetic field and the smaller the coercive force, except when the major axis of each of the soft magnetic alloy particles is strongly oriented in a direction parallel to the direction of application of the external magnetic field. Since the soft magnetic alloy powder having a high space filling rate has a small amount of strain when processed into an iron core, the coercive force decreases. Therefore, a soft magnetic alloy powder configured by soft magnetic alloy particles close to a spherical shape is required.

For example, Japanese Patent Application Laid-Open No. 2018-50053 discloses a method of pulverizing a continuous plate-shaped amorphous alloy called a ribbon to obtain a soft magnetic alloy powder.

### SUMMARY

The soft magnetic alloy powder described in Japanese Patent Application Laid-Open No. 2018-50053 is a pulverized powder of an amorphous alloy ribbon. In Japanese Patent Application Laid-Open No. 2018-50053, the thickness of the amorphous alloy ribbon is preferably 10 μm or more and 50 μm or less (i.e., from 10 μm to 50 μm). According to Examples of Japanese Patent Application Laid-Open No. 2018-50053, it is described that, after the amorphous alloy ribbon was subjected to coarse pulverization, medium pulverization, and fine pulverization successively with mutually different pulverizers, the obtained pulverized powder having passed through a sieve of aperture 106 μm (diagonal 150 μm) was removed, and as a result, soft magnetic alloy particles included in the soft magnetic alloy powder had edges and a principal surface of the ribbon had no pulverized evidence. That is, it is shown that the soft magnetic alloy particles included in the soft magnetic alloy powder produced by the method described in Japanese Patent Application Laid-Open No. 2018-50053 have a ribbon principal surface close to a plane and a pulverized surface exposed by pulverization, and a boundary therebetween is sharp. Therefore, the soft magnetic alloy particles included in the soft magnetic alloy powder produced by the method described in Japanese Patent Application Laid-Open No. 2018-50053 have a small minor-axis length/major-axis length ratio and are not spherical particles. Therefore, the soft magnetic alloy powder produced by the method described in Japanese Patent Application Laid-Open No. 2018-50053 is easily magnetically saturated, and the coercive force is large due to the shape magnetic anisotropy of the soft magnetic alloy particles. As a result, a problem arises in that the iron loss of the magnetic core is large.

Accordingly, the present disclosure provides a soft magnetic alloy powder which is hardly magnetically saturated and has a favorable coercive force. Also, the present disclosure provides a magnetic core containing the soft magnetic alloy powder, a magnetic application component including the magnetic core, and a noise suppression sheet containing the soft magnetic alloy powder.

A soft magnetic alloy powder of the present disclosure includes soft magnetic alloy particles having an amorphous phase. Each of the soft magnetic alloy particles has chemical composition represented by FeₐSi_{b}B_{c}C_{d}PₑCu_{f}Sn_{g}M1ₕM2ᵢ, where M1 is one or more elements of Co and Ni, M2 is one or more elements of Ti, Zr, Hf, Nb, Ta, Mo, W, Cr, Al, Mn, Ag, V, Zn, As, Sb, Bi, Y, and a rare earth element, and 79≤a+h+i≤86, 0≤b≤5, 7.2≤c≤12.2, 0.1≤d≤3, 7.3≤c+d≤13.2, 0.5≤e≤10, 0.4≤f≤2, 0.3≤g≤6, 0≤h≤30, 0≤i≤5, and a+b+c+d+e+f+g+h+i=100 (parts by mol) are satisfied. An average minor-axis length/major-axis length ratio of two-dimensional projected shapes of the soft magnetic alloy particles is 0.69 or more and 1 or less (i.e., from 0.69 to 1).

A magnetic core of the present disclosure contains the soft magnetic alloy powder of the present disclosure.

A magnetic application component of the present disclosure includes the magnetic core of the present disclosure.

A noise suppression sheet of the present disclosure contains the soft magnetic alloy powder of the present disclosure.

According to the present disclosure, it is possible to provide a soft magnetic alloy powder which is hardly magnetically saturated and has a favorable coercive force.

### BRIEF EXPLANATION OF DRAWINGS

FIG. 1 is an SEM image of an example of a soft magnetic alloy powder of the present disclosure;

FIG. 2 is an enlarged SEM image of a portion surrounded by a broken line in FIG. 1; and

FIG. 3 is a perspective view schematically illustrating an example of a coil as a magnetic application component.

### DETAILED DESCRIPTION

Hereinafter, a soft magnetic alloy powder of the present disclosure will be described.

However, the present disclosure is not limited to the following configuration, and can be appropriately modified and applied without changing the gist of the present disclosure. The present disclosure also includes a combination of two or more desirable configurations of the embodiments described below.

### [Soft Magnetic Alloy Powder]

A soft magnetic alloy powder of the present disclosure includes soft magnetic alloy particles having an amorphous phase. Each of the soft magnetic alloy particles has a predetermined chemical composition, and an average minor-axis length/major-axis length ratio of two-dimensional projected shapes of the soft magnetic alloy particles is 0.69 or more and 1 or less (i.e., from 0.69 to 1).

Since the soft magnetic alloy powder of the present disclosure includes soft magnetic alloy particles having a shape close to a spherical shape, the soft magnetic alloy powder is hardly magnetically saturated and has a favorable coercive force.

For example, a ribbon satisfying a predetermined chemical composition produced by a single-roll liquid quenching method is mechanically pulverized to produce a pulverized powder. When the predetermined chemical composition is satisfied, the pulverized powder is put into a device for applying a shear stress and a compressive stress, and a stress is applied to a contact point of the plurality of pulverized particles to apply plastic deformation, whereby soft magnetic alloy particles having a shape close to a spherical shaped, which has a large minor-axis length/major-axis length ratio, can be produced. Specifically, the average minor-axis length/major-axis length ratio of average two-dimensional projected shapes of the soft magnetic alloy particles included in the soft magnetic alloy powder can be set to 0.69 or more and 1 or less (i.e., from 0.69 to 1).

Each of the soft magnetic alloy particles included in the soft magnetic alloy powder of the present disclosure has chemical composition represented by FeₐSi_{b}B_{c}C_{d}PₑCu_{f}Sn_{g}M1ₕM2ᵢ. In the chemical composition, a+b+c+d+e+f+g+h+i=100 (parts by mol) is satisfied.

The role of the element contained in the soft magnetic alloy particles of the present disclosure will be described below.

Fe (iron) is an essential element for exhibiting ferromagnetic properties. When the amount of Fe is too large, the amorphous-forming ability is lowered, and coarse crystal particles are generated after liquid quenching or after a heat treatment, so that the coercive force is deteriorated.

A part of Fe may be substituted with M1 which is one or more elements of Co and Ni. In this case, M1 is preferably 30 atom % or less of the entire chemical composition. Therefore, M1 satisfies 0≤h≤30.

A part of Fe may be substituted with M2 which is one or more elements of Ti, Zr, Hf, Nb, Ta, Mo, W, Cr, Al, Mn, Ag, V, Zn, As, Sb, Bi, Y, and a rare earth element. In this case, M2 is preferably 5 atom % or less of the entire chemical composition. Therefore, M2 satisfies 0≤i≤5.

A part of Fe may be substituted with any one of M1 and M2, or may be substituted with both of M1 and M2. The sum of Fe, M1, and M2 satisfies 79≤a+h+i≤86.

Si (silicon) also has a function of increasing a second crystallization starting temperature to widen the temperature range of the heat treatment. However, when the amount of Si is too large, the amorphous-forming ability is lowered, and the coercive force is deteriorated. From the above, Si satisfies 0≤b≤5 and preferably satisfies 0≤b≤3.

B (boron) is an essential element that enhances the bonding strength between Fe atoms around the B atom, facilitates plastic deformation in a spheroidization step, and enhances the amorphous-forming ability. However, when the amount of B is too large, the plastic deformation becomes dominant, and the minor-axis length/major-axis length ratio is deteriorated. Since the atomic amount of B is small, the saturation flux density is less likely to decrease when the atomic amount of B is increased, but when the atomic amount of B is too large, the saturation flux density decreases. From the above, B satisfies 7.2≤c≤12.2.

C (carbon) is an essential element that enhances the bonding strength between Fe atoms around the C atom, facilitates plastic deformation in the spheroidization step, and enhances the amorphous-forming ability. However, when the amount of C is too large, the plastic deformation becomes dominant, and the minor-axis length/major-axis length ratio is deteriorated. Since the atomic amount of C is small, the saturation flux density is less likely to decrease when the atomic amount of C is increased, but when the atomic amount of C is too large, the saturation flux density decreases. When the amount of C is too large, austenite is generated and the coercive force is deteriorated. From the above, C satisfies 0.1≤d≤3.

The sum of B and C satisfies 7.3≤c+d≤13.2.

P (phosphorus) has an effect of reducing an average crystal grain size after the heat treatment to reduce the coercive force. P also has an effect of enhancing the amorphous-forming ability. When the amount of P is too large, the saturation flux density decreases, and the amorphous-forming ability decreases, so that the coercive force is deteriorated. P has a negative enthalpy of mixing with Cu, and thus has an effect of uniformly dispersing Cu to promote crystal nucleation during the heat treatment. From the above, P satisfies 0.5≤e≤10.

Cu (copper) has an effect of promoting crystal nucleation of the first crystallization during the heat treatment, and thus has an effect of obtaining a crystal structure having a small average crystal grain size after the heat treatment to reduce the coercive force. When the amount of Cu is too large, the amorphous-forming ability is lowered, and conversely, the coercive force is deteriorated. From the above, Cu satisfies 0.4≤f≤2.

Sn (tin) has an effect of facilitating brittle fracture by a shear stress and facilitating pulverization. When the amount of Sn is too small, the elastic deformation becomes dominant, strain is likely to accumulate, and the coercive force is deteriorated. When the amount of Sn is too large, the brittleness becomes too strong to make spheroidization difficult, and the saturation flux density decreases. From the above, Sn satisfies 0.3≤g≤6.

Each of the soft magnetic alloy particles included in the soft magnetic alloy powder of the present disclosure may contain 0.5 wt % or less of S (sulfur) when a sum of components of the chemical composition is regarded as 100 wt %. S is an element having an effect of facilitating brittle fracture by a shear stress and facilitating pulverization. On the other hand, when the amount of S is too large, the brittleness becomes too strong to make spheroidization difficult, and magnetic properties is deteriorated.

The soft magnetic alloy particles included in the soft magnetic alloy powder of the present disclosure may have only an amorphous phase. That is, a volume rate of the amorphous phase in the soft magnetic alloy particles may be 100%.

Alternatively, the soft magnetic alloy particles included in the soft magnetic alloy powder of the present disclosure may have a crystal phase in addition to the amorphous phase. In this case, the volume rate of the amorphous phase in the soft magnetic alloy particles is preferably 10% or more. On the other hand, the volume rate of the amorphous phase in the soft magnetic alloy particles is preferably 50% or less and further preferably 35% or less. In other words, the volume rate of the crystal phase in the soft magnetic alloy particles is preferably 90% or less. On the other hand, the volume rate of the crystal phase in the soft magnetic alloy particles is preferably 50% or more and further preferably 65% or more.

In the step of spheroidizing the soft magnetic alloy particles by applying a shear stress and a compressive stress to the soft magnetic alloy particles, when the brittleness is too strong, the soft magnetic alloy particles are only broken but not spheroidized. Particles produced by pulverizing a highly brittle ribbon have a shape in which the principal surface of the ribbon remains and edge portion is provided as described in Japanese Patent Application Laid-Open No. 2018-50053. In the present disclosure, when the above chemical composition is satisfied, it is possible to have both of a property that the soft magnetic alloy particles are easily pulverized in a pulverization step and a property that the soft magnetic alloy particles are easily plastically deformed in the spheroidization step in order to obtain spherical particles. On the other hand, in Japanese Patent Application Laid-Open No. 2018-50053, the chemical composition for making the particle shape spherical has not been examined.

The soft magnetic alloy powder of the present disclosure is preferably produced as follows.

First, raw materials are weighed so as to have a predetermined chemical composition. The raw material used in the present disclosure are not particularly limited, and may be a reagent for research and development, pure iron and an iron alloy used for electromagnetic steel sheets and other casting products, or a pure substance made with a single element. For example, as a raw material of Fe (iron), electrolytic iron or a cast and rolled cut product may be used. A raw material of Si (silicon) may be ferrosilicon, or may be a silicon wafer and silicon pieces of the raw material. A raw material of B (boron) may be metallic boron or ferroboron. For example, there are various kinds of ferroboron used in a rare-earth magnet depending on the content of boron and the content of impurities, but ferroboron used in the present disclosure is not particularly limited. A raw material of C (carbon) may be a simple substance such as graphite, or may be an iron alloy such as pig iron or SiC. A raw material of P (phosphorus) may be phosphorous iron (ferrophosphorus), or may be a simple substance. A raw material of Cu (copper) may be electrolytic copper, or may be a wire material such as an electric wire and a cut product of the wire material. A raw material of Sn (tin) may be a simple metal Sn or an alloy.

The raw material may contain inevitable impurity elements other than Fe, Si, B, C, P, Cu, Sn, M1, and M2. When the weight of the soft magnetic alloy is regarded as 100%, the weight of the inevitable impurity elements is preferably 2% or less, further preferably 1% or less, and particularly preferably 0.5% or less. Typical examples of the inevitable impurity elements include O (oxygen).

Raw materials weighed so as to have a predetermined chemical composition are heated and dissolved to make the chemical concentration as uniform as possible. The heating method is not particularly limited. An induction heating furnace, an external heating furnace, or arc heating may be employed.

The atmosphere during heating is not particularly limited. The atmosphere may be atmospheric air, or may be an inert atmosphere such as nitrogen or argon. When oxygen is contained in the atmosphere, the chemical composition of the molten metal may change due to an oxidation reaction during heating. In particular, silicon and boron are likely to react with oxygen. In consideration of elements that react with oxygen and are discharged to the outside of the alloy and the amounts thereof, it is preferable to determine a weighing value so that a predetermined chemical composition is obtained after the completion of dissolution.

The temperature of the alloy dissolved into a molten metal is not particularly limited, but a temperature and a retention time at which the chemical composition inside the molten metal is as uniform as possible may be selected.

A container in which the raw materials are put is not particularly limited. A refractory material such as alumina, mullite, or zirconia may be used.

The molten metal may be poured into a mold and cast to produce a mother alloy. In order to reduce the manufacturing cost, the production of the mother alloy can be omitted. In the case of producing a mother alloy, the mother alloy is pulverized as necessary, and then the pulverized mother alloy is heated and dissolved.

The molten metal is cooled and solidified to produce a ribbon. The cooling and solidification method is not particularly limited. The ribbon may be, for example, a continuous body having a length of 1 m or more, and may have a plate shape or a flake shape. A single-roll liquid quenching method or a twin-roll liquid quenching method may be used. However, in order to produce a ribbon containing an amorphous phase, a cooling and solidifying method and conditions with a high cooling rate are preferable.

The thickness of the ribbon is not particularly limited, but when the thickness is too large, it takes a long time to cool and solidify and further cool the ribbon to a temperature equal to or lower than the crystallization starting temperature, so that it is difficult to generate an amorphous phase. Therefore, it is preferable to reduce the thickness to a range in which the amorphous phase can be generated. The thickness of the ribbon affects the time required for pulverization in the next pulverization step and the particle size after pulverization. In the case of producing a powder having a small average particle size, it is preferable to reduce the thickness of the ribbon, but the time required for pulverization becomes long. From the above, the thickness of the ribbon is preferably 10 μm or more and 60 μm or less (i.e., from 10 μm to 60 μm), further preferably 14 μm or more and 40 μm or less (i.e., from 14 μm to 40 μm), and particularly preferably 18 μm or more and 30 μm or less (i.e., from 18 μm to 30 μm). In the case of using a single-roll liquid quenching method, it is preferable to set the circumferential speed of the cooling roll or the extrusion pressure of the molten metal so as to obtain a predetermined average thickness.

The material for the cooling roll is not particularly limited. Pure copper may be selected, or a copper alloy such as beryllium copper or chromium zirconia copper may be selected. Liquid such as water or oil may be circulated inside the cooling roll for cooling. It is preferable that the temperature of the liquid such as water or oil immediately before the flow path in the cooling roll is lower because the cooling rate can be increased, but the temperature may be higher than room temperature when a defect occurs on the surface of the same roll due to dew condensation. As a material for the nozzle for supplying the molten metal to the surface of the cooling roll, quartz, boron nitride, or the like can be selected. The nozzle shape may be a rectangular slit or a round hole.

The ribbon preferably contains an amorphous phase, and may contain, for example, crystal grains having a body-centered cubic structure. The surface of the ribbon may have an oxide phase, and may contain one or more of magnetite, wustite, silicon oxide, and boron oxide.

A stress is applied to the obtained ribbon to produce a pulverized powder. For example, although the pulverization method is not particularly limited and examples thereof include a pin mill, a hammer mill, a feather mill, a sample mill, a ball mill, and a stamp mill, the average particle size of the pulverized powder is preferably 300 μm or less.

A shear stress and a compressive stress are simultaneously applied to the pulverized powder to plastically deform the pulverized powder, thereby producing particles close to a spherical shape. The machine is not particularly limited, and for example, a surface modification/complexing apparatus such as a hybridization system (manufactured by Nara Machinery Co., Ltd.) is preferred. The pulverized powder is chipped. Next, under the condition that a plurality of particles are assembled into a single particle by plastic deformation, soft magnetic alloy particles closer to a spherical shape are obtained, which is preferable.

For the purpose of removing particles having an excessively small particle size, foreign matters, and the like, a classification step may be appropriately provided before and after the pulverization step and a spheroidization treatment. The classifier and the classification conditions are not particularly limited, and may be a sieve classifier or an air flow classifier.

The soft magnetic alloy particles produced by the above method may be subjected to a heat treatment to improve soft magnetic properties. Strain is introduced into the soft magnetic alloy particles by the pulverization step and the spheroidization step. The strain introduced into the soft magnetic alloy particles causes an increase in coercive force to enhance the magnetic anisotropy. In order to avoid deterioration of the coercive force, the soft magnetic alloy particles are heated to a temperature at which diffusion of atoms is promoted and the temperature is maintained, whereby the atoms are diffused so as to relax the strain, and the strain can be reduced.

By heating the soft magnetic alloy particles having the chemical composition of the present disclosure at a temperature equal to or higher than a first crystallization starting temperature, a fine crystal structure can be generated. The first crystallization starting temperature is a temperature at which a crystal phase having a body-centered cubic structure starts to be formed when an amorphous phase having the chemical composition of the present disclosure is heated from room temperature. The first crystallization starting temperature depends on the heating temperature increasing rate, the first crystallization starting temperature increases as the heating temperature increasing rate increases, and the first crystallization starting temperature decreases as the heating temperature increasing rate decreases. When the crystal phase having a body-centered cubic structure is sufficiently generated, the saturation flux density is improved, and the coercive force decreases. Since the crystal phase is a phase in which a solute such as Si is solid-solved in a-Fe, the saturation flux density is high.

The volume rate of the crystal phase in the soft magnetic alloy particles is preferably 50% or more and particularly preferably 65% or more. On the other hand, the volume rate of the crystal phase in the soft magnetic alloy particles is preferably 90% or less. The balance is an amorphous phase. Therefore, the volume rate of the amorphous phase in the soft magnetic alloy particles is preferably 50% or less and further preferably 35% or less. On the other hand, the volume rate of the amorphous phase in the soft magnetic alloy particles is preferably 10% or more.

The smaller the crystal grain size of the crystal phase contained in the soft magnetic alloy particles is, the smaller the magnetic anisotropy becomes, which is preferable. The crystal grain size of the crystal phase is preferably 30 nm or less, further preferably 25 nm or less, and particularly preferably 20 nm or less. On the other hand, the crystal grain size of the crystal phase is, for example, 5 nm or more.

The higher the temperature increasing rate, the more active the crystal nucleation and a fine crystal structure can be obtained, which is preferable. However, when the temperature increasing rate is too high, the crystal growth is promoted by heat generation associated with a transformation reaction from the amorphous phase to the crystal phase, and the coercive force is deteriorated. The temperature increasing rate is, for example, preferably 20° C./min or more and 100000° C./min or less (i.e., from 20° C./min to 100000° C./min) and further preferably 100° C./min or more and 50000° C./min or less (i.e., from 100° C./min to 50000° C./min).

When a sample temperature reaches the second crystallization starting temperature, a second crystallization reaction is started. In the second crystallization reaction, for example, a Fe—B compound or a Fe—P compound is produced. Since the Fe—B compound or the Fe—P compound has hard magnetism, the coercive force of the powder increases. Therefore, the heat treatment is preferably performed at a temperature equal to or higher than the first crystallization starting temperature and equal to or lower than the second crystallization starting temperature.

The atmosphere of the heat treatment is not particularly limited, but the oxygen concentration is preferably low. When the atmosphere contains oxygen, an oxide layer is formed on the surface of the soft magnetic alloy particles. The oxide layer functions as an insulating film, but reduces the saturation flux density.

The cooling conditions of the heat treatment is not particularly limited. The heating principle of a heat treatment furnace is not particularly limited, but it is preferable to satisfy the above temperature increasing rate. For example, the temperature of an infrared lamp annealing furnace can be raised at a maximum of 1000° C./min. Alternatively, a soft sample may be brought close to or into contact with a solid substance heated in advance. Alternatively, heated gas may be brought into contact with a sample. Microwave heating or induction heating by electromagnetic waves having a wavelength shorter than that of microwaves may be used.

The minor-axis length/major-axis length ratio of each of the soft magnetic alloy particles is measured from a two-dimensional projection view of the appearance of the soft magnetic alloy particle. For example, there are a method of analyzing an image captured with a scanning electron microscope (SEM), a method of analyzing an image captured with microscope, and a method of using a particle image analysis system such as iSpect DIA-10 manufactured by SHIMADZU CORPORATION, FPIA, or VHX-6000. In examples described below, the contour of the particle is extracted from an image captured with the SEM, and the minor-axis length/major-axis length ratio is analyzed with automatic image analysis software “WinROOF”. An image is prepared so that the number of particles is 100 or more except for particles having no contour due to overlapping of the particles, and the average minor-axis length/major-axis length ratio of 100 particles is defined as the minor-axis length/major-axis length ratio of the soft magnetic alloy powder. Also in the case of using soft magnetic alloy particles for a magnetic core of a magnetic application component, there is almost no change in the size of the soft magnetic alloy particles. Therefore, the minor-axis length/major-axis length ratio can be determined similarly to that of each of the soft magnetic alloy particles by polishing a section of the magnetic core and imaging the section with an SEM or the like.

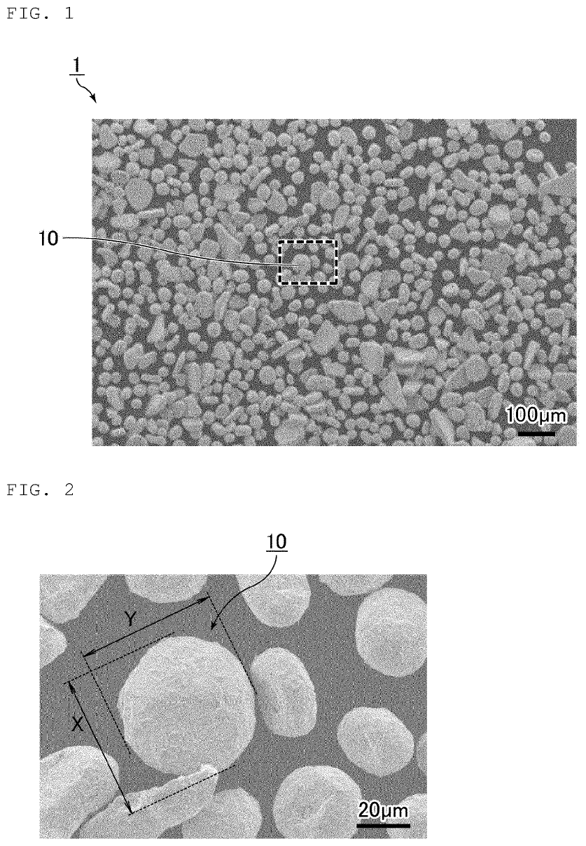

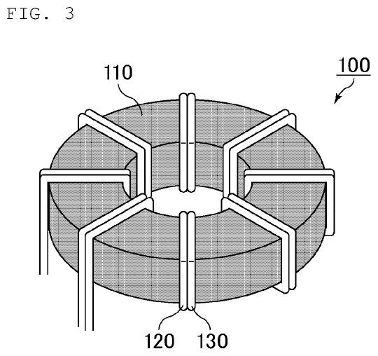

FIG. 1 is an SEM image of an example of a soft magnetic alloy powder of the present disclosure. FIG. 2 is an enlarged SEM image of a portion surrounded by a broken line in FIG. 1.

As for soft magnetic alloy particles 10 contained in the soft magnetic alloy powder 1 illustrated in FIG. 1, as shown in FIG. 2, a ratio (Y/X) of a minor-axis length Y to a major-axis length X is determined. Here, the major axis of each of the soft magnetic alloy particles 10 means the longest straight line among the straight lines connecting any two points on the contour of the particle. On the other hand, the minor axis of each of the soft magnetic alloy particles 10 means a straight line passing through a point bisecting the major axis and orthogonal to the major axis among straight lines connecting any two points on the contour of the particle.

In the soft magnetic alloy powder of the present disclosure, the average major-axis length and the average minor-axis length of the soft magnetic alloy particles are not particularly limited as long as the average minor-axis length/major-axis length ratio of the soft magnetic alloy particles satisfies 0.69 or more and 1 or less (i.e., from 0.69 to 1). The average major-axis length of the soft magnetic alloy particles is, for example, in a range of 25 μm or more and 45 μm or less (i.e., from 25 μm to 45 μm), and the average minor-axis length of the soft magnetic alloy particles is, for example, in a range of 25 μm or more and 45 μm or less (i.e., from 25 μm to 45 μm).

The use application of the soft magnetic alloy powder of the present disclosure is not particularly limited. The soft magnetic alloy powder of the present disclosure can be processed into, for example, a magnetic core used for magnetic application components such as motors, reactors, inductors, and various coils, or a noise suppression sheet. A magnetic core containing the soft magnetic alloy powder of the present disclosure, a magnetic application component including the magnetic core, and a noise suppression sheet containing the soft magnetic alloy powder of the present disclosure are also included in the present disclosure.

For example, a magnetic core can be molded by kneading a binder dissolved in a solvent and a soft magnetic alloy powder, filling the resulting mixture in a mold, and applying a pressure thereto. A resin constituting the binder is not particularly limited, and may be a thermosetting resin such as an epoxy resin, a phenolic resin, or a silicon resin, or may be a mixture of a thermoplastic resin and a thermosetting resin. After an extra solvent is dried, the molded magnetic core can be heated to increase the mechanical strength. The heat treatment may be performed in order to relax the introduced strain of the soft magnetic alloy particles by the pressure during molding. For example, when the heat treatment is performed at a temperature of 300° C. or higher and 450° C. or lower (i.e., from 300° C. to 450° C.) under a condition in which magnetic properties are not adversely affected due to the resin being burned or volatilized, strain is easily relaxed.

FIG. 3 is a perspective view schematically illustrating an example of a coil as a magnetic application component.

A coil 100 illustrated in FIG. 3 includes a magnetic core 110 containing the soft magnetic alloy powder of the present disclosure, and a primary winding 120 and a secondary winding 130 wound around the magnetic core 110. In the coil 100 illustrated in FIG. 3, the primary winding 120 and the secondary winding 130 are bifilar-wound around the magnetic core 110 having an annular toroidal shape.

The structure of the coil is not limited to the structure of the coil 100 illustrated in FIG. 3. For example, one winding may be wound around a magnetic core having an annular toroidal shape. A structure including an element body containing the soft magnetic alloy powder of the present disclosure and a coil conductor embedded in the element body, and the like may be employed.

### EXAMPLES

Hereinafter, examples more specifically disclosing the present disclosure will be described. The present disclosure is not limited only to these examples.

### Example 1

Raw materials were weighed so as to have a predetermined chemical composition. The total weight of the raw materials was set to 150 g. As a raw material of Fe, MAIRON (purity: 99.95%) manufactured by Toho Zinc Co., Ltd. was used. As a raw material of Si, granular silicon (purity: 99.999%) manufactured by Kojundo Chemical Laboratory Co., Ltd. was used. As a raw material of B, granular boron (purity: 99.5%) manufactured by Kojundo Chemical Laboratory Co., Ltd. was used. As a raw material of C, powdered graphite (purity: 99.95%) manufactured by Kojundo Chemical Laboratory Co., Ltd. was used. As a raw material of P, massive iron phosphide Fe₃P (purity: 99%) manufactured by Kojundo Chemical Laboratory Co., Ltd. was used. As a raw material of Cu, chip-shaped copper (purity: 99.9%) manufactured by Kojundo Chemical Laboratory Co., Ltd. was used. As a raw material of Sn, granular tin (purity: 99.9%) manufactured by Kojundo Chemical Laboratory Co., Ltd. was used.

The raw materials were filled in an alumina crucible (U1 material) manufactured by TEP CORPORATION, heated by induction heating so that the sample temperature reached 1300° C., and maintained for 1 minute so as to be dissolved.

The dissolving atmosphere was set to argon. The molten metal obtained by dissolving the raw materials was poured into a copper mold and cooled and solidified to obtain a mother alloy. The mother alloy was pulverized into a size of about 3 mm to 10 mm with a jaw crusher. Subsequently, the pulverized mother alloy was processed into a ribbon by a single-roll liquid quenching apparatus. Specifically, 15 g of the mother alloy was filled in a nozzle made with a quartz material, and dissolved by heating to 1200° C. by induction heating in an argon atmosphere. The molten metal obtained by dissolving the mother alloy was supplied to the surface of a cooling roll made with a copper material to obtain a ribbon having a thickness of 15 μm to 25 μm and a width of 1 mm to 4 mm. The molten metal outflow gas was set to 0.015 MPa. The hole diameter of the quartz nozzle was set to 0.7 mm. The circumferential speed of the cooling roll was set to 50 m/s. A distance between the cooling roll and the quartz nozzle was set to 0.27 mm. The length of the ribbon varied depending on the chemical composition, and there were samples in which a plurality of short ribbons of about 50 mm were obtained and samples in which the length of the ribbon was long such as 5 m or more.

The obtained ribbon was pulverized using Sample Mill SAM manufactured by Nara Machinery Co., Ltd. The rotation speed of SAM was set to 15000 rpm.

The pulverized powder obtained by pulverization with SAM was subjected to a spheroidization treatment using a surface modification/complexing apparatus. As the surface modification/complexing apparatus, a hybridization system NHS-0 type manufactured by Nara Machinery Co., Ltd. was used. The rotation speed was set to 13000 rpm and the treatment time was set to 30 minutes.

The pulverized powder was passed through a sieve with a mesh size of 38 μm to remove coarse particles remaining on the sieve. Subsequently, the powder was passed through a sieve with a mesh size of 20 μm to remove fine particles passing through the sieve, and the soft magnetic alloy powder remaining on the sieve was recovered. The obtained soft magnetic alloy powder was used as Samples 1 to 55.

The chemical composition of each sample was measured by inductively coupled plasma atomic emission spectroscopy (ICP-AES). However, C was measured by a combustion method.

The appearance of soft magnetic alloy particles included in the soft magnetic alloy powder was imaged using a scanning electron microscope manufactured by JEOL Ltd. The contour of the obtained SEM image was extracted using image processing software “WinROOF”, and 100 soft magnetic alloy particles were selected except for particles having an incorrect contour due to overlapping of the soft magnetic alloy particles. The average minor-axis length/major-axis length ratio was calculated by automatic analysis.

Saturation magnetization Ms was measured with a vibrating sample type magnetization measuring instrument (VSM). A capsule for powder measurement was filled with a soft magnetic alloy powder, and compacted so that the powder did not move when a magnetic field was applied.

An apparent density ρ was measured by a pycnometer method. The replacement gas was He.

A saturation flux density Bs was calculated from the saturation magnetization Ms measured with the VSM and the apparent density ρ measured by the pycnometer method using Formula (1) below.

Bs=4π·Ms·ρ (1)

A coercive force Hc was measured with Coercive Force Meter K-HC1000 manufactured by Tohoku Steel Co., Ltd. A capsule for powder measurement was filled with a soft magnetic alloy powder, and compacted so that the powder did not move when a magnetic field was applied.

A volume rate Va of the amorphous phase was determined by a peak area intensity ratio of an X-ray diffraction intensity profile measured by a 0-20 method of an X-ray diffractometer. A halo attribute to the amorphous phase and a (110) diffraction peak of a crystal phase having a body-centered cubic structure were obtained near 2θ=44°. The volume rate Va of the amorphous phase was determined by Formula (2) below, where the area intensity of the halo attribute to the amorphous phase was designated as Ia, and the (110) peak area intensity of a crystal phase having a body-centered cubic structure was designated as Ic. A volume rate Vc of a crystal phase having a body-centered cubic structure can also be determined by Formula (3) below.

Va=Ia/(Ia+Ic) (2)

Vc=Ic/(Ia+Ic) (3)

The chemical composition, the average minor-axis length/major-axis length ratio, the volume rate Va of the amorphous phase, the saturation flux density Bs, and the coercive force Hc of Samples 1 to 10 are shown in Table 1.

TABLE 1

| | | | | | | | | | Average | | Saturation | |
|---|---|---|---|---|---|---|---|---|---|---|---|---|
| | Composition formula | | | | | | | | minor-axis | Volume | flux | |
| | FeₐSi_{b}B_{c}C_{d}PₑCu_{f}Sn_{g} | | | | | | | | length/major- | ratio Va of | density | Coercive |
| Sample | Fe | Si | B | C | P | Cu | Sn | B + C | axis length | amorphous | Bs | force Hc |
| No. | a | b | c | d | e | f | g | c + d | ratio | phase | [T] | [A/m] |
| *1 | 84.8 | 0.5 | 9.4 | 1.0 | 3.5 | 0.8 | 0.0 | 10.4 | 0.67 | 83% | 1.62 | 1900 |
| 2 | 84.6 | 0.5 | 9.4 | 1.0 | 3.4 | 0.8 | 0.3 | 10.4 | 0.76 | 100% | 1.60 | 1390 |
| 3 | 84.4 | 0.5 | 9.4 | 1.0 | 3.4 | 0.8 | 0.5 | 10.4 | 0.76 | 100% | 1.59 | 1290 |
| 4 | 84.2 | 0.5 | 9.3 | 1.0 | 3.4 | 0.8 | 0.8 | 10.3 | 0.80 | 100% | 1.57 | 1200 |
| 5 | 84.0 | 0.5 | 9.3 | 1.0 | 3.4 | 0.8 | 1.0 | 10.3 | 0.83 | 100% | 1.54 | 1140 |
| 6 | 83.1 | 0.5 | 9.2 | 1.0 | 3.4 | 0.8 | 2.0 | 10.2 | 0.78 | 100% | 1.55 | 1160 |
| 7 | 82.3 | 0.5 | 9.1 | 1.0 | 3.3 | 0.8 | 3.0 | 10.1 | 0.74 | 100% | 1.54 | 1150 |
| 8 | 81.4 | 0.5 | 9.0 | 1.0 | 3.3 | 0.8 | 4.0 | 10.0 | 0.69 | 100% | 1.56 | 1160 |
| 9 | 80.6 | 0.5 | 8.9 | 1.0 | 3.3 | 0.7 | 5.0 | 9.9 | 0.71 | 100% | 1.48 | 1180 |
| 10 | 79.7 | 0.5 | 8.8 | 1.0 | 3.3 | 0.7 | 6.0 | 9.8 | 0.71 | 100% | 1.46 | 1160 |

In Table 1, the sample numbers marked with * are comparative examples outside the scope of the present disclosure. The same applies to Table 2-1, Table 2-2, and Table 3.

From Table 1, in Sample 1 not containing Sn in the chemical composition, the average minor-axis length/major-axis length ratio is 0.67, and the coercive force is increased. On the other hand, in Samples 2 to 10 containing Sn in the chemical composition and satisfying 0.3≤g≤6, the average minor-axis length/major-axis length ratio is 0.69 to 0.83, and the coercive force is decreased.

### Example 2

The first crystallization starting temperature and the second crystallization starting temperature of Samples 1 to 55 were measured with a differential scanning calorimeter (DSC). The temperature was raised from room temperature to 650° C. at 20° C./min, and the heat generation of the sample at each temperature was measured. At this time, a platinum sample container was used. Argon (99.999%) was selected as an atmosphere, and the gas flow rate was set to 1 L/min. The amount of the sample was set to 15 mg to 20 mg. The intersection of the tangent of a DSC curve at a temperature equal to or lower than the temperature at which heat generation by crystallization is started and the maximum slope tangent at the rising of the exothermic peak of the sample by the crystallization reaction was defined as the crystallization starting temperature.

The sample was subjected to the heat treatment at a temperature higher than the measured first crystallization starting temperature by 20° C. to generate nanocrystals from the amorphous phase. As a result, the amorphous phase and the nanocrystals coexisted in the sample. As the heat treatment furnace, an infrared lamp annealing furnace RTA manufactured by ADVANCE RIKO, Inc. was used. The heat treatment atmosphere was argon, and carbon was used as an infrared susceptor. On a carbon susceptor having a diameter of 4 inches, 2 g of the sample was placed, and a carbon susceptor having a diameter of 4 inches was further placed thereon. A control thermocouple was inserted into a thermocouple insertion hole formed in the lower carbon susceptor. The temperature increasing rate was set to 400° C./min. The retention time at the heat treatment temperature was set to 1 minute. The cooling was natural cooling, and the temperature reached 100° C. or lower in approximately 30 minutes.

The chemical composition, the average minor-axis length/major-axis length ratio, the saturation flux density Bs, and the coercive force Hc of each sample were measured by the same method as in Example 1. The crystal state of the soft magnetic alloy powder after the heat treatment was checked using an X-ray diffractometer. In the X-ray diffraction intensity profile measured by the 0-20 method, a halo attribute to the amorphous phase and a (110) diffraction peak of an α-Fe crystal phase having a body-centered cubic structure were obtained near 2θ=44°. An average statistical particle size of the α-Fe crystal phase was calculated from the diffraction peak using the Scherrer equation shown in the following (4). The presence or absence of a Fe—B compound phase that deteriorates the coercive force was checked by determination on whether the diffraction peak was present near 20=46°.

D=K·λ/(β·cos θ) (4)

These results are shown in Table 2-1 and Table 2-2.

TABLE 2-1

| | | | | | | | | | | | | | | | | | | | | Average | | | | |
|---|---|---|---|---|---|---|---|---|---|---|---|---|---|---|---|---|---|---|---|---|---|---|---|---|
| | Composition formula | | | | | | | | | | | | | | | | | | | minor-axis | | | | |
| | FeₐSi_{b}B_{c}C_{d}PₑCuₜSn_{g}M1ₕM2ᵢ | | | | | | | | | | | | | | | | | | | length/major- | Saturation flux | Coercive | Fe—B | α-Fe crystal |
| Sample | Fe | Si | B | C | P | Cu | Sn | Ni | Co | Nb | Cr | Mo | Hf | Ta | Zr | Al | Mn | Fe + M1 + M2 | B + C | axis length | density Bs | force Hc | compound | grain size |
| No. | a | b | C | d | e | f | g | h | h | i | i | i | i | i | i | i | i | a + h + i | c + d | ratio | [T] | [A/m] | phase | [nm] |
| *1 | 84.8 | 0.5 | 9.4 | 1.0 | 3.5 | 0.8 | 0.0 | — | — | — | — | — | — | — | — | — | — | 84.8 | 10.4 | 0.67 | 1.75 | 250 | Present | Unmeasurable |
| 2 | 84.6 | 0.5 | 9.4 | 1.0 | 3.4 | 0.8 | 0.3 | — | — | — | — | — | — | — | — | — | — | 84.6 | 10.4 | 0.76 | 1.74 | 180 | Absent | 22 |
| 3 | 84.4 | 0.5 | 9.4 | 1.0 | 3.4 | 0.8 | 0.5 | — | — | — | — | — | — | — | — | — | — | 84.4 | 10.4 | 0.76 | 1.73 | 159 | Absent | 18 |
| 4 | 84.2 | 0.5 | 9.3 | 1.0 | 3.4 | 0.8 | 0.8 | — | — | — | — | — | — | — | — | — | — | 84.2 | 10.3 | 0.81 | 1.72 | 115 | Absent | 16 |
| 5 | 84.0 | 0.5 | 9.3 | 1.0 | 3.4 | 0.8 | 1.0 | — | — | — | — | — | — | — | — | — | — | 84.0 | 10.3 | 0.83 | 1.70 | 71 | Absent | 15 |
| 6 | 83.1 | 0.5 | 9.2 | 1.0 | 3.4 | 0.8 | 2.0 | — | — | — | — | — | — | — | — | — | — | 83.1 | 10.2 | 0.74 | 1.68 | 70 | Absent | 25 |
| 7 | 82.3 | 0.5 | 9.1 | 1.0 | 3.3 | 0.8 | 3.0 | — | — | — | — | — | — | — | — | — | — | 82.3 | 10.1 | 0.72 | 1.67 | 72 | Absent | 23 |
| 8 | 81.4 | 0.5 | 9.0 | 1.0 | 3.3 | 0.8 | 4.0 | — | — | — | — | — | — | — | — | — | — | 81.4 | 10.0 | 0.69 | 1.64 | 71 | Absent | 25 |
| 9 | 80.6 | 0.5 | 8.9 | 1.0 | 3.3 | 0.7 | 5.0 | — | — | — | — | — | — | — | — | — | — | 80.6 | 9.9 | 0.71 | 1.62 | 68 | Absent | 16 |
| 10 | 79.7 | 0.5 | 8.8 | 1.0 | 3.3 | 0.7 | 6.0 | — | — | — | — | — | — | — | — | — | — | 79.7 | 9.8 | 0.71 | 1.60 | 60 | Absent | 18 |
| *11 | 78.0 | 5.0 | 9.2 | 1.0 | 5.2 | 0.8 | 0.8 | — | — | — | — | — | — | — | — | — | — | 78.0 | 10.2 | 0.75 | 1.58 | 97 | Absent | 17 |
| 12 | 79.0 | 4.2 | 11.2 | 2.0 | 2.0 | 0.8 | 0.8 | — | — | — | — | — | — | — | — | — | — | 79.0 | 13.2 | 0.69 | 1.65 | 86 | Absent | 23 |
| 13 | 86.0 | 0.5 | 8.4 | 1.0 | 2.5 | 0.8 | 0.8 | — | — | — | — | — | — | — | — | — | — | 86.0 | 9.4 | 0.76 | 1.77 | 150 | Absent | 17 |
| *14 | 87.0 | 0.0 | 8.4 | 1.0 | 2.0 | 0.8 | 0.8 | — | — | — | — | — | — | — | — | — | — | 87.0 | 9.4 | 0.76 | 1.79 | 276 | Present | Unmeasurable |
| 15 | 84.0 | 0.0 | 10.0 | 1.0 | 3.4 | 0.8 | 0.8 | — | — | — | — | — | — | — | — | — | — | 84.0 | 11.0 | 0.73 | 1.74 | 120 | Absent | 21 |
| 16 | 83.5 | 5.0 | 8.2 | 1.0 | 1.0 | 0.5 | 0.8 | — | — | — | — | — | — | — | — | — | — | 83.5 | 9.2 | 0.76 | 1.72 | 145 | Absent | 21 |
| *17 | 82.8 | 7.0 | 7.6 | 0.5 | 0.7 | 0.8 | 0.6 | — | — | — | — | — | — | — | — | — | — | 82.8 | 8.1 | 0.77 | 1.69 | 249 | Present | Unmeasurable |
| *18 | 85.0 | 2.0 | 6.0 | 1.0 | 4.4 | 0.8 | 0.8 | — | — | — | — | — | — | — | — | — | — | 85.0 | 7.0 | 0.80 | 1.71 | 201 | Absent | 43 |
| 19 | 84.0 | 1.5 | 7.2 | 1.0 | 4.7 | 0.8 | 0.8 | — | — | — | — | — | — | — | — | — | — | 84.0 | 8.2 | 0.78 | 1.70 | 115 | Absent | 19 |
| 20 | 83.0 | 0.5 | 12.2 | 1.0 | 1.7 | 0.8 | 0.8 | — | — | — | — | — | — | — | — | — | — | 83.0 | 13.2 | 0.69 | 1.75 | 140 | Absent | 19 |
| *21 | 83.0 | 0.2 | 13.0 | 0.5 | 1.7 | 0.8 | 0.8 | — | — | — | — | — | — | — | — | — | — | 83.0 | 13.5 | 0.67 | 1.67 | 99 | Absent | 20 |
| *22 | 84.5 | 1.3 | 9.2 | 0.0 | 3.4 | 0.8 | 0.8 | — | — | — | — | — | — | — | — | — | — | 84.5 | 9.2 | 0.76 | 1.73 | 255 | Present | Unmeasurable |
| 23 | 84.0 | 0.9 | 10.0 | 0.1 | 3.4 | 0.8 | 0.8 | — | — | — | — | — | — | — | — | — | — | 84.0 | 10.1 | 0.75 | 1.73 | 104 | Absent | 23 |
| 24 | 83.5 | 0.5 | 8.0 | 3.0 | 3.4 | 0.8 | 0.8 | — | — | — | — | — | — | — | — | — | — | 83.5 | 11.0 | 0.73 | 1.72 | 152 | Absent | 25 |
| *25 | 84.7 | 0.2 | 9.0 | 4.0 | 0.5 | 0.8 | 0.8 | — | — | — | — | — | — | — | — | — | — | 84.7 | 13.0 | 0.67 | 1.75 | 115 | Absent | 21 |
| *26 | 82.4 | 0.5 | 12.0 | 3.0 | 0.5 | 0.8 | 0.8 | — | — | — | — | — | — | — | — | — | — | 82.4 | 15.0 | 0.66 | 1.75 | 98 | Absent | 25 |
| *27 | 84.2 | 2.0 | 10.0 | 2.2 | 0.0 | 0.8 | 0.8 | — | — | — | — | — | — | — | — | — | — | 84.2 | 12.2 | 0.71 | 1.76 | 211 | Absent | 45 |
| 28 | 83.9 | 1.0 | 11.0 | 2.0 | 0.5 | 0.8 | 0.8 | — | — | — | — | — | — | — | — | — | — | 83.9 | 13.0 | 0.69 | 1.77 | 170 | Absent | 21 |
| 29 | 80.8 | 0.3 | 7.2 | 0.1 | 10.0 | 0.8 | 0.8 | — | — | — | — | — | — | — | — | — | — | 80.8 | 7.3 | 0.80 | 1.60 | 99 | Absent | 18 |
| *30 | 79.3 | 0.5 | 7.4 | 0.2 | 11.0 | 0.8 | 0.8 | — | — | — | — | — | — | — | — | — | — | 79.3 | 7.6 | 0.80 | 1.57 | 144 | Absent | 23 |
| *31 | 84.6 | 1.0 | 9.2 | 1.0 | 3.4 | 0.0 | 0.8 | — | — | — | — | — | — | — | — | — | — | 84.6 | 10.2 | 0.74 | 1.76 | 224 | Absent | 49 |
| 32 | 84.5 | 0.7 | 9.2 | 1.0 | 3.4 | 0.4 | 0.8 | — | — | — | — | — | — | — | — | — | — | 84.5 | 10.2 | 0.74 | 1.75 | 128 | Absent | 24 |
| 33 | 81.0 | 0.5 | 11.0 | 1.3 | 3.4 | 2.0 | 0.8 | — | — | — | — | — | — | — | — | — | — | 81.0 | 12.3 | 0.71 | 1.65 | 96 | Absent | 21 |
| *34 | 84.0 | 0.5 | 8.7 | 1.0 | 2.0 | 3.0 | 0.8 | — | — | — | — | — | — | — | — | — | — | 84.0 | 9.7 | 0.75 | 1.67 | 244 | Present | Unmeasurable |
| *35 | 79.0 | 0.5 | 8.5 | 1.0 | 3.3 | 0.7 | 7.0 | — | — | — | — | — | — | — | — | — | — | 79.0 | 9.5 | 0.67 | 1.58 | 57 | Absent | 25 |

TABLE 2-2

| | | | | | | | | | | | | | | | | | | | | Average | | | | |
|---|---|---|---|---|---|---|---|---|---|---|---|---|---|---|---|---|---|---|---|---|---|---|---|---|
| | Composition formula | | | | | | | | | | | | | | | | | | | minor-axis | | | | |
| | FeₐSi_{b}B_{c}C_{d}PₑCuₜSn_{g}M1ₕM2ᵢ | | | | | | | | | | | | | | | | | | | length/major- | Saturation flux | Coercive | Fe—B | α-Fe crystal |
| Sample | Fe | Si | B | C | P | Cu | Sn | Ni | Co | Nb | Cr | Mo | Hf | Ta | Zr | Al | Mn | Fe + M1 + M2 | B + C | axis length | density Bs | force Hc | compound | grain size |
| No. | a | b | C | d | e | f | g | h | h | i | i | i | i | i | i | i | i | a + h + i | c + d | ratio | [T] | [A/m] | phase | [nm] |
| 36 | 54.0 | 0.5 | 9.2 | 1.0 | 3.7 | 0.8 | 0.8 | 30.0 | — | — | — | — | — | — | — | — | — | 84.0 | 10.2 | 0.74 | 1.73 | 110 | Absent | 21 |
| *37 | 43.0 | 0.8 | 10.0 | 1.2 | 3.4 | 0.8 | 0.8 | 40.0 | — | — | — | — | — | — | — | — | — | 83.0 | 11.2 | 0.73 | 1.72 | 230 | Present | Unmeasurable |
| 38 | 54.4 | 0.4 | 9.2 | 1.0 | 3.4 | 0.8 | 0.8 | — | 30.0 | — | — | — | — | — | — | — | — | 84.4 | 10.2 | 0.74 | 1.74 | 109 | Absent | 25 |
| *39 | 43.8 | 0.5 | 9.5 | 1.2 | 3.4 | 0.8 | 0.8 | — | 40.0 | — | — | — | — | — | — | — | — | 83.8 | 10.7 | 0.73 | 1.74 | 241 | Present | Unmeasurable |
| 40 | 81.0 | 0.5 | 8.0 | 0.5 | 3.4 | 0.8 | 0.8 | — | — | 5.0 | — | — | — | — | — | — | — | 86.0 | 8.5 | 0.77 | 1.61 | 142 | Absent | 19 |
| *41 | 80.0 | 0.5 | 8.0 | 0.5 | 3.4 | 0.8 | 0.8 | — | — | 6.0 | — | — | — | — | — | — | — | 86.0 | 8.5 | 0.77 | 1.59 | 283 | Present | Unmeasurable |
| 42 | 81.0 | 0.5 | 8.0 | 0.5 | 3.4 | 0.8 | 0.8 | — | — | — | 5.0 | — | — | — | — | — | — | 86.0 | 8.5 | 0.77 | 1.60 | 120 | Absent | 16 |
| *43 | 80.0 | 0.5 | 8.0 | 0.5 | 3.4 | 0.8 | 0.8 | — | — | — | 6.0 | — | — | — | — | — | — | 86.0 | 8.5 | 0.77 | 1.59 | 293 | Present | Unmeasurable |
| 44 | 81.0 | 0.5 | 8.0 | 0.5 | 3.4 | 0.8 | 0.8 | — | — | — | — | 5.0 | — | — | — | — | — | 86.0 | 8.5 | 0.77 | 1.61 | 106 | Absent | 17 |
| *45 | 80.0 | 0.5 | 8.0 | 0.5 | 3.4 | 0.8 | 0.8 | — | — | — | — | 6.0 | — | — | — | — | — | 86.0 | 8.5 | 0.77 | 1.59 | 291 | Present | Unmeasurable |
| 46 | 81.0 | 0.5 | 8.0 | 0.5 | 3.4 | 0.8 | 0.8 | — | — | — | — | — | 5.0 | — | — | — | — | 86.0 | 8.5 | 0.77 | 1.60 | 151 | Absent | 19 |
| *47 | 80.0 | 0.5 | 8.0 | 0.5 | 3.4 | 0.8 | 0.8 | — | — | — | — | — | 6.0 | — | — | — | — | 86.0 | 8.5 | 0.77 | 1.59 | 281 | Present | Unmeasurable |
| 48 | 81.0 | 0.5 | 8.0 | 0.5 | 3.4 | 0.8 | 0.8 | — | — | — | — | — | — | 5.0 | — | — | — | 86.0 | 8.5 | 0.77 | 1.60 | 167 | Absent | 23 |
| *49 | 80.0 | 0.5 | 8.0 | 0.5 | 3.4 | 0.8 | 0.8 | — | — | — | — | — | — | 6.0 | — | — | — | 86.0 | 8.5 | 0.77 | 1.59 | 271 | Present | Unmeasurable |
| 50 | 81.0 | 0.5 | 8.0 | 0.5 | 3.4 | 0.8 | 0.8 | — | — | — | — | — | — | — | 5.0 | — | — | 86.0 | 8.5 | 0.77 | 1.61 | 154 | Absent | 15 |
| *51 | 80.0 | 0.5 | 8.0 | 0.5 | 3.4 | 0.8 | 0.8 | — | — | — | — | — | — | — | 6.0 | — | — | 86.0 | 8.5 | 0.77 | 1.59 | 297 | Present | Unmeasurable |
| 52 | 81.0 | 0.5 | 8.0 | 0.5 | 3.4 | 0.8 | 0.8 | — | — | — | — | — | — | — | — | 5.0 | — | 86.0 | 8.5 | 0.77 | 1.60 | 108 | Absent | 20 |
| *53 | 80.0 | 0.5 | 8.0 | 0.5 | 3.4 | 0.8 | 0.8 | — | — | — | — | — | — | — | — | 6.0 | — | 86.0 | 8.5 | 0.77 | 1.59 | 281 | Present | Unmeasurable |
| 54 | 81.0 | 0.5 | 8.0 | 0.5 | 3.4 | 0.8 | 0.8 | — | — | — | — | — | — | — | — | — | 5.0 | 86.0 | 8.5 | 0.77 | 1.60 | 105 | Absent | 25 |
| *55 | 80.0 | 0.5 | 8.0 | 0.5 | 3.4 | 0.8 | 0.8 | — | — | — | — | — | — | — | — | — | 6.0 | 86.0 | 8.5 | 0.77 | 1.59 | 283 | Present | Unmeasurable |

The following matters can be checked from Table 2-1 and Table 2-2.

As for Samples 1 to 10, as in Table 1, when g is 0, the average minor-axis length/major-axis length ratio is 0.67, and the coercive force is increased. On the other hand, in Samples 2 to 10, 0.3≤g≤6 is satisfied. The average minor-axis length/major-axis length ratio of the samples is 0.69 to 0.83, and the coercive force is decreased.

As for Samples 11 to 14, when a is less than 79, the saturation flux density is decreased. On the other hand, when a is more than 86 as in Sample 14, the amorphous-forming ability is lowered, and coarse crystal particles (Fe—B compound phase) are generated after liquid quenching or after the heat treatment, so that the coercive force is deteriorated.

As for Samples 15 to 17, when Si is contained, these samples also have a function of increasing a second crystallization starting temperature to widen the temperature range of the heat treatment. On the other hand, when the amount of Si is too large as in Sample 17, the amorphous-forming ability is lowered, and coarse crystal particles (Fe—B compound phase) are generated after liquid quenching or after the heat treatment, so that the coercive force is deteriorated.

As for Samples 18 to 21, when the amount of B is small as in Sample 18, the coercive force increases. On the other hand, when the amount of B is too large as in Sample 21, the plastic deformation becomes dominant, and the minor-axis length/major-axis length ratio is deteriorated.

As for Samples 22 to 25, when C is contained, the coercive force can be decreased. On the other hand, when the amount of C is too large as in Sample 25, the plastic deformation becomes dominant, and the minor-axis length/major-axis length ratio is deteriorated.

As for Samples 12, 18, 21, 26, and 29, since c+d is small in Sample 18, the coercive force is increased. On the other hand, since c+d is large in Samples 21 and 26, the plastic deformation becomes dominant, and the minor-axis length/major-axis length ratio is deteriorated.

As for Samples 27 to 30, when P is contained, the coercive force can be decreased. On the other hand, when the amount of P is too large as in Sample 30, the saturation flux density decreases.

As for Samples 31 to 34, when Cu is contained, the coercive force can be decreased. On the other hand, when the amount of Cu is too large as in Sample 34, the amorphous-forming ability is lowered, and conversely, the coercive force is deteriorated.

As for Samples 2, 10, and 35, when Sn is contained, the coercive force can be decreased. On the other hand, when the amount of Sn is too large as in Sample 35, the minor-axis length/major-axis length ratio is deteriorated, and the saturation flux density also decreases.

As for Samples 36 to 39, also by substituting a part of Fe with Co or Ni, a soft magnetic alloy powder having favorable saturation flux density and coercive force can be formed. However, when the amount of substitution with Co or Ni increases as in Samples 37 and 39, the amorphous-forming ability decreases, and the coercive force increases.

As for Samples 40 to 55, also by substituting a part of Fe with M2 which is one or more elements of Ti, Zr, Hf, Nb, Ta, Mo, W, Cr, Al, Mn, Ag, V, Zn, As, Sb, Bi, Y, and a rare earth element, a soft magnetic alloy powder having favorable saturation flux density and coercive force can be formed. However, when the amount of substitution with M2 increases as in Samples 41, 43, 45, 47, 49, 51, 53, and 55, the saturation flux density decreases, and the coercive force increases.

### Example 3

An insulating film was formed on the surface of the soft magnetic alloy powder produced in Example 2. With respect to 30 g of the soft magnetic alloy particles, 8.5 g of isopropyl alcohol (IPA), 8.5 g of 9% aqueous ammonia, and 1.14 g of 30% PLYSURF AL were mixed. Subsequently, a mixed solution of 7.9 g of IPA and 2.1 g of tetraethoxysilane (TEOS) was mixed in three portions of 1.0 g each, and the mixture was filtered with a filter paper. The sample recovered on the filter paper was washed with acetone, then heated and dried at a temperature condition of 80° C. for 60 minutes, and then heat-treated at a temperature condition of 140° C. for 30 minutes to obtain a composite soft magnetic alloy powder.

The composite soft magnetic alloy powder was processed into a toroidal magnetic core. When the weight of the composite soft magnetic alloy powder was regarded as 100 wt %, 1.5 wt % of a phenolic resin PC-1 and 3.0 wt % of acetone were mixed in a mortar. Acetone was volatilized under conditions of a temperature of 80° C. and a retention time of 30 minutes in an explosion-proof oven, and then the sample was filled in a mold and molded into a toroidal shape having an outer diameter of 8 mm and an inner diameter of 4 mm by hot molding at a pressure of 60 MPa and a temperature of 180° C.

The relative initial permeability of the magnetic core was measured with an impedance analyzer E4991A and a magnetic material test fixture 16454A manufactured by Keysight Technologies.

A copper wire was wound around the magnetic core in order to measure the core loss (iron loss). The diameter of the copper wire was set to 0.26 mm. The number of turns of the primary winding for excitation and the number of turns of the secondary winding for detection were the same as 20 turns, and bifilar winding was performed. The frequency condition was set to 1 MHz, and the maximum flux density was set to 20 mT. The coercive force and core loss of the magnetic core are shown in Table 3.

TABLE 3

| | Pulverized powder composition formula | | | | | | | | Core loss Pcv of |
|---|---|---|---|---|---|---|---|---|---|
| | FeₐSi_{b}B_{c}C_{d}PₑCu_{f}Sn_{g} | | | | | | | Coercive force Hc of | magnetic core |
| | Fe | Si | B | C | P | Cu | Sn | magnetic core | @20 mT-1 MHz |
| Sample No. | a | b | c | d | e | f | g | [A/m] | [kW/m³] |
| *1 | 84.8 | 0.5 | 9.4 | 1.0 | 3.5 | 0.8 | 0.0 | 237 | 1622 |
| 5 | 84.0 | 0.5 | 9.3 | 1.0 | 3.4 | 0.8 | 1.0 | 162 | 806 |
| *56 | 84.0 | 0.5 | 9.3 | 1.0 | 3.4 | 0.8 | 1.0 | 302 | Unmeasurable |

From Table 3, in Sample 1, the coercive force of the magnetic core is high, and the core loss is increased. On the other hand, in Sample 5, the coercive force of the magnetic core is low, and the core loss is decreased. Sample 56 is a comparative example pulverized by a sample mill. In Sample 56, the minor-axis length/major-axis length ratio was small, the filling rate was poor, and the core loss was high, which was unmeasurable.

What is claimed is:

1. A soft magnetic alloy powder comprising:
soft magnetic alloy particles having an amorphous phase, wherein
the soft magnetic alloy particles have chemical composition represented by FeₐSi_{b}B_{c}C_{d}PₑCu_{f}Sn_{g}M1ₕM2ᵢ, where
M1 is one or more elements of Co and Ni,
M2 is one or more elements of Ti, Zr, Hf, Nb, Ta, Mo, W, Cr, Al, Mn, Ag, V, Zn, As, Sb, Bi, Y, and a rare earth element, and
79≤a+h+i≤86,
0≤b≤5,
7.2≤c≤12.2,
0.1≤d≤3,
7.3≤c+d≤13.2,
0.5≤e≤10,
0.4≤f≤2,
0.3≤g≤6,
0≤h≤30,
0≤i≤5, and
a+b+c+d+e+f+g+h+i=100 (parts by mol) are satisfied, and
an average minor-axis length/major-axis length ratio of two-dimensional projected shapes of the soft magnetic alloy particles is from 0.69 or more to 1.

2. The soft magnetic alloy powder according to claim 1, wherein
the soft magnetic alloy particles further contain S of 0.5 wt % or less when a sum of components of the chemical composition is regarded as 100 wt %.

3. The soft magnetic alloy powder according to claim 1, wherein
a volume rate of the amorphous phase in the soft magnetic alloy particles is 10% or more.

4. The soft magnetic alloy powder according to claim 1, wherein
a crystal grain size of a crystal phase contained in the soft magnetic alloy particles is from 5 nm to 30 nm.

5. A magnetic core comprising the soft magnetic alloy powder according to claim 1.

6. A magnetic application component comprising the magnetic core according to claim 5.

7. A noise suppression sheet comprising the soft magnetic alloy powder according to claim 1.

8. The soft magnetic alloy powder according to claim 2, wherein
a volume rate of the amorphous phase in the soft magnetic alloy particles is 10% or more.

9. The soft magnetic alloy powder according to claim 2, wherein
a crystal grain size of a crystal phase contained in the soft magnetic alloy particles is from 5 nm to 30 nm.

10. The soft magnetic alloy powder according to claim 3, wherein
a crystal grain size of a crystal phase contained in the soft magnetic alloy particles is from 5 nm to 30 nm.

11. The soft magnetic alloy powder according to claim 8, wherein
a crystal grain size of a crystal phase contained in the soft magnetic alloy particles is from 5 nm to 30 nm.

12. A magnetic core comprising the soft magnetic alloy powder according to claim 2.

13. A magnetic core comprising the soft magnetic alloy powder according to claim 3.

14. A magnetic core comprising the soft magnetic alloy powder according to claim 4.

15. A magnetic application component comprising the magnetic core according to claim 12.

16. A magnetic application component comprising the magnetic core according to claim 13.

17. A magnetic application component comprising the magnetic core according to claim 14.

18. A noise suppression sheet comprising the soft magnetic alloy powder according to claim 2.

19. A noise suppression sheet comprising the soft magnetic alloy powder according to claim 3.

20. A noise suppression sheet comprising the soft magnetic alloy powder according to claim 4.
